(19) United States
(12) Patent Application Publication
(10) Pub. No.: US 2006/0001281 A1
(43) Pub. Date: Jan. 5, 2006

(54) Apparatus for the sanitary collection and disposal of animal waste

(76) Inventor: John J. Hubert, Manahawkin, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 11/092,234

(22) Filed: Mar. 29, 2005

Related U.S. Application Data
(63) Continuation-in-part of application No. 10/880,677, filed on Jun. 30, 2004, now abandoned.

(51) Int. Cl. A01K 29/00

(52) U.S. Cl. 294/1.5

(57) ABSTRACT

In one embodiment, the apparatus is adapted to be held beneath and/or behind an animal and comprises a frame having an inner perimeter defining an opening and an outer perimeter, at least two flanges coupled to the outer perimeter of the frame for securing a bag to the frame, and at least one leg coupled to the frame for supporting the frame in a spaced apart relation relative to a support surface.

### CROSS REFERENCE TO RELATED APPLICATIONS

The present invention is a continuation-in-part of U.S. patent application Ser. No. 10/880,677, filed Jun. 30, 2004, which is herein incorporated by reference in its entirety.

### FIELD OF THE INVENTION

The present invention relates generally to pet accessories and relates more specifically to the sanitary collection of animal waste for disposal.

### BACKGROUND OF THE DISCLOSURE

The collection and disposal of animal waste has become a matter of increasing public concern. Accumulated animal waste that is generated in public places and is not properly disposed of creates an environmental hazard and is unsightly and unaesthetic. For this reason, pet owners that do not properly dispose of waste generated by their pets in public places are subject to fines in many cities.

Many devices have been developed to aid pet owners in the collection and disposal of animal waste, which can be a delicate and unpleasant task. Among these are a number of devices that are designed to hold a disposable bag beneath an animal in order to catch and collect waste. The disposable bags are removably anchored to the devices by various mechanisms. For instance, some bags include an elastic band that secures the bag around a portion of the device. Other bags may be tied around a portion of the device, or secured by a clamping mechanism that is coupled to the device.

While these devices are effective in collecting animal waste, removal of the disposable bags from the devices for disposal tends to be awkward and ungainly. For instance, bags may not easily detach completely from the devices, causing their contents to spill as users try to remove them. Moreover, the user may be subjected to unsanitary contact with the waste products as he or she attempts to remove the bag from the frame.

Thus, there is a need in the art for an apparatus for the sanitary collection and disposal of animal waste.

### SUMMARY OF THE INVENTION

In one embodiment, the apparatus is adapted to be held beneath and/or behind an animal and comprises a frame having an inner perimeter defining an opening and an outer perimeter, at least two flanges coupled to the outer perimeter of the frame for securing a bag to the frame, and at least one leg coupled to the frame for supporting the frame in a spaced apart relation relative to a support surface.

### BRIEF DESCRIPTION OF THE DRAWINGS

The teachings of the present invention can be readily understood by considering the following detailed description in conjunction with the accompanying drawings, in which:

FIG. 1 is a top plan view of one embodiment of an apparatus for animal waste collection according to the present invention;

FIG. 2 is a side view of the apparatus illustrated in FIG. 1;

FIG. 3 is a plan view of one embodiment of a bag adapted for use with the apparatus;

FIG. 4 is a top plan view of the apparatus illustrated in FIG. 1 in a collapsed position;

FIG. 5 is a top plan view of one embodiment of a hinge for coupling the handle to the frame;

FIG. 6 is a cross sectional view of a portion of the hinge of FIG. 5 taken along line A-A′;

FIG. 7 is a top plan view of another embodiment of an apparatus for animal waste collection according to the present invention;

FIG. 8 is a top view illustrating another embodiment of an apparatus for animal waste collection according to the present invention;

FIG. 9 is a side view of the apparatus of FIG. 8 having a bag deployed thereon for catching animal waste; and

FIG. 10 is a side view of the apparatus of FIG. 8 being supported upon a support surface.

To facilitate understanding, identical reference numerals have been used, where possible, to designate identical elements that are common to the figures.

### DETAILED DESCRIPTION

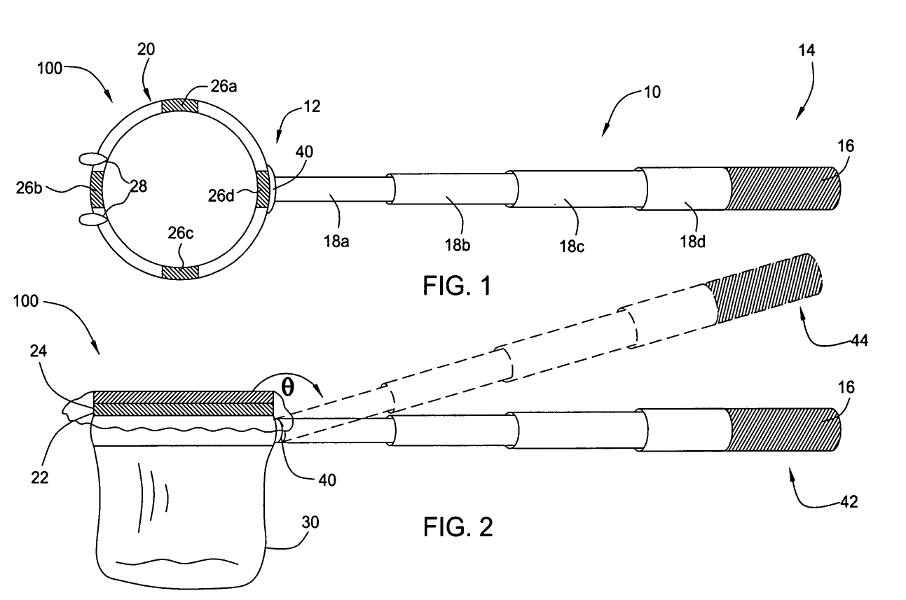

FIG. 1 is a top plan view of one embodiment of an apparatus 100 for animal waste collection according to the present invention. The apparatus 100 is configured to be held beneath and/or behind an animal, in order to catch and store waste for disposal. The apparatus comprises a handle 10, having a first end 12 and a second end 14, and a frame 20. In one embodiment, the apparatus 100 is at least partially formed of a strong, lightweight and rust-resistant material such as aluminum.

FIG. 2 is a side view of the apparatus 100 illustrated in FIG. 1. The frame 20 is adapted to support a bag 30 for collecting animal waste. In one embodiment, illustrated in FIG. 1, the frame 20 is circular in shape; however, frame 20 may take any shape that allows the frame 20 to securely support the bag 30 for use. In one embodiment, a first side 22 of the frame 20 is lined with a layer 24 of Velcro® that extends around substantially the full perimeter of the frame 20. In another embodiment, illustrated in FIG. 1, a finite number of Velcro® segments 26a-26d (hereinafter collectively referred to as “segments 26”) are spaced at intervals around the perimeter of the frame 20. Although four Velcro® segments 26 are illustrated, those skilled in the art will appreciate that any number of Velcro® segments 26 may be deployed on the first side 22 of the frame 20.

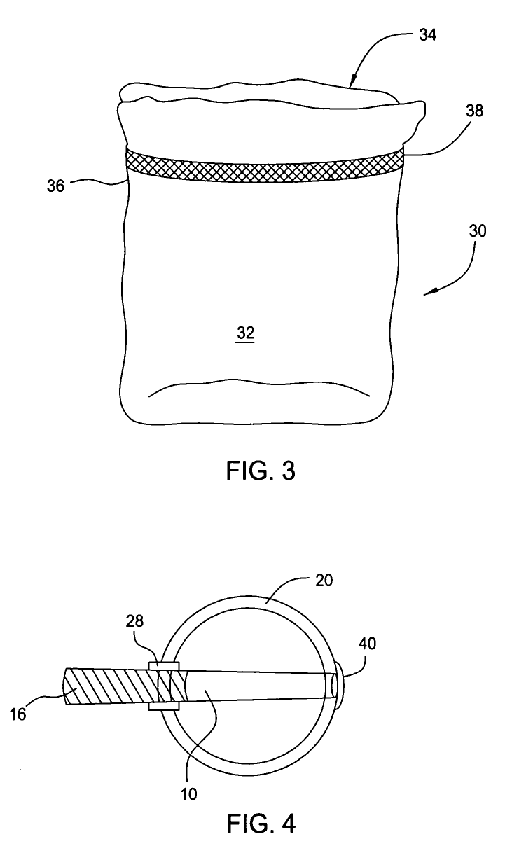

FIG. 3 is a plan view of one embodiment of a bag 30 adapted for use with the apparatus 100. The bag 30 is sized to be supported on the frame 20 of the waste collection device 100. The bag 30 comprises an interior volume 32 for collecting animal waste and an open end 34 adapted for attachment to the apparatus 100. In one embodiment, the bag 30 is formed of a disposable material that is economical to manufacture in large quantities, such as plastic. At least a portion of an outer perimeter 36 of the bag's open end 34 includes a Velcro® strip 38 that is adapted to engage the Velcro® layer 24 or segments 26 on the frame 20 of the apparatus 100. Those skilled in the art will appreciate that although the strip 38 is illustrated as encircling the full outer perimeter 36 of the bag 30, any number of smaller Velcro® segments may be positioned around the outer perimeter 36 as well.

The Velcro® enables the bag 30 to be easily and securely attached to the frame 20 for use. Moreover, the Velcro® enables the bag 30 to be removed from the frame 20 with substantially less difficulty than that involved in removing similar bags from existing devices. A user may therefore easily dispose of animal waste without spilling or coming into unsanitary contact with the contents of the bag 30.

In one embodiment, the handle 10 of the apparatus 100 is a telescopic handle comprising a plurality of concentric segments 18a-18d that may be extended or collapsed to adjust the length of the handle 10. Although the apparatus 100 is illustrated as comprising four concentric segments 18a-18d, those skilled in the art will appreciate that any number of concentric segments may form the telescopic handle 10. The first end 12 of the handle 10 is coupled to the frame 20. In one embodiment, a hinge 40 couples the frame 20 to the first end 12 of the handle 10.

In one embodiment, the hinge 40 is adapted to enable a user to vary an angle θ between the handle 10 and the frame 20, e.g., so that the user may adjust the position of the apparatus 100 beneath and/or behind the user's pet. In one embodiment, the hinge 40 is configured to allow a user to fixably set the angle θ at one of a finite number of positions (e.g., a first position 42 and a second position 44, illustrated in phantom). Furthermore, the hinge 40 enables the apparatus 100 to be collapsed and folded, e.g., for storage. A portion of the frame 20 opposite the hinge 40 may further include a latch 28 for locking the handle 10 in placed when the apparatus 100 is collapsed.

FIG. 4 is a top plan view of the apparatus 100 in a collapsed position. As illustrated, the concentric segments 18a-18d of the telescopic handle 10 may be collapsed to shorten the length of the handle 10. The handle 10 may then be rotated around the hinge 40 so that it folds over and lies flush against the frame 20, thereby collapsing the apparatus 100 into a more compact form, e.g., for storage.

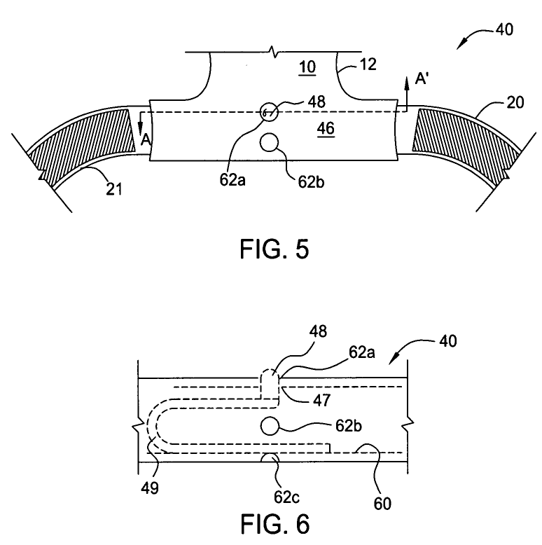

FIG. 5 is a top plan view of one embodiment of a hinge 40 for coupling the handle 10 to the frame 20, and FIG. 6 is a cross sectional view of the hinge 40 illustrated in FIG. 5 taken along line A-A′. Referring simultaneously to FIGS. 5 and 6, in one embodiment, a portion 60 of the frame 20 that is coupled to the handle 10 (e.g., at the first end 12) is tubular or rounded in shape, and the remainder of the frame's circumference 21 is substantially flat in cross section. The first end 12 of the handle 10 ends in a substantially tubular section 46 that is adapted to house the tubular portion 60 of the frame 20.

The tubular portion 60 of the frame 20 is substantially hollow and houses a button 48 that is adapted to project through a button hole 47 in the outer circumference of the tubular portion 60. The button 48 is biased, e.g., by a spring 49, to project outward through the button hole 47. The button 48 is adapted to be engaged by a user to manually set the angle θ (e.g., in a manner similar to buttons used to open patio umbrellas), as described in further detail below.

The tubular section 46 of the handle 10 is substantially hollow and comprises one or more holes 62a-62c (hereinafter collectively referred to as “holes 62”) formed in the outer circumference thereof. The holes 62 are substantially collinear around a portion of the circumference, and each hole 62 is further adapted for concentric alignment with the button 48 in the tubular portion 60 of the frame 20.

The holes 62 in the tubular section 46 of the handle 10 are adapted to engage the button 48 in the tubular portion 60 of the frame 20 in order to set and reversibly lock the angle θ between the handle 10 and the frame 20. When the apparatus 100 is locked in a position, the button 48 will project through one of the holes 62 in the tubular section 46 of the handle 10. To lock the apparatus 100 in an alternate position, a user pushes inward on the button 48, thereby disengaging the tubular portion 60 of the frame 20 from the tubular section 46 handle 10. The tubular portion 60 of the frame 20 and the tubular section 46 handle 10 are then rotated relative to each other until another hole 62 in the tubular section 46 of the handle 10 engages the button 48 and reversibly locks the apparatus 100 in another position.

Those skilled in the art will appreciate that although the tubular section 46 of the handle 10 is illustrated as having three holes 62 (e.g., corresponding to three positions to which the apparatus 100 may be set), the tubular section 46 of the handle 10 may comprise any number of holes depending on the number of possible positions to which the apparatus 100 may be set.

In one embodiment, a frame 20 having a tubular portion 60, such as the frame illustrated in FIGS. 5 and 6, has Velcro® disposed only on the flat portions of the frame 20 (e.g., not on the tubular portion 60).

Referring back to FIG. 1, in one embodiment, the second end 14 of the handle 10 comprises a grip 16 for enabling a user to securely grasp the handle 10. In one embodiment, the grip 16 comprises foam rubber, though in other embodiments the grip 16 may comprise any material that allows a user to establish a secure grasp on the handle 10.

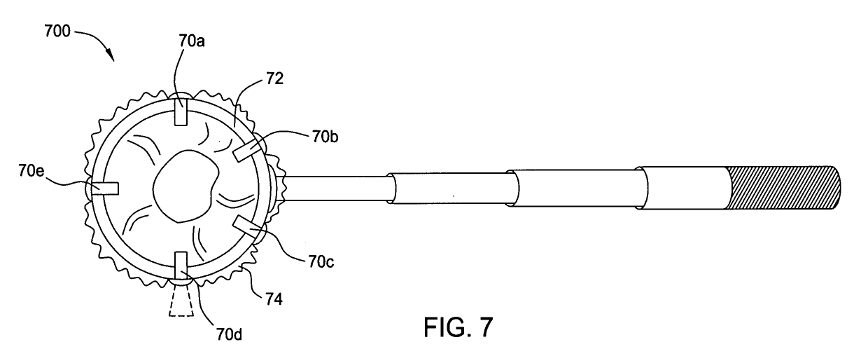

FIG. 7 is a top plan view of another embodiment of an apparatus 700 for animal waste collection according to the present invention. The apparatus 700 is substantially similar to the apparatus 100 in structure; however, in place of Velcro® layers or sections, a plurality of clamps or clips 70a-70e (hereinafter collectively referred to as “clips 70″”) are spaced around the perimeter of the frame 72 in order to support a disposable bag 74. The clips 70 are adapted to flip open (e.g., or outward from the frame perimeter, as illustrated in phantom at clip 70d) to allow a user to position a disposable bag on the frame 20. When the clips 70 are closed, the clips 70 clamp the bag 74 securely to the frame 72. Moreover, the clips 70 are easily disengaged for removal and disposal of the bag 74 and its contents. Although the embodiment illustrated in FIG. 7 shows five clips 70 coupled to the frame 72, those skilled in the art will recognize that any number of clips 70 may be deployed to securely anchor the bag 74 to the frame 72.

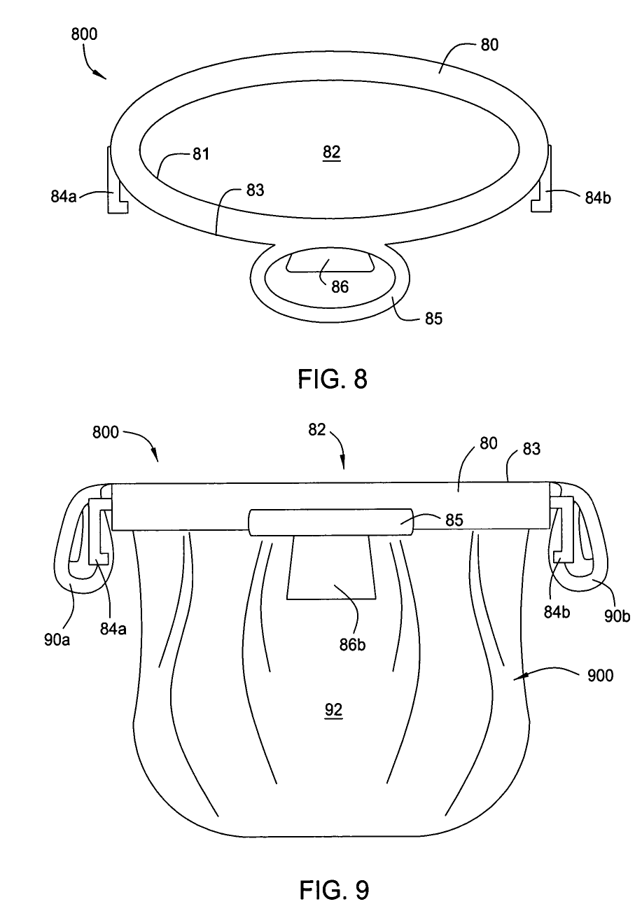

FIG. 8 is a top view illustrating another embodiment of an apparatus 800 for animal waste collection according to the present invention. Like the apparatus 100 illustrated in FIGS. 1-6, the apparatus 800 is configured to be held beneath and/or behind an animal, in order to catch and store waste for disposal. The apparatus comprises a frame 80 having at an inner perimeter 81 that defines an opening 82 and an outer perimeter 83. Although the frame 80 is illustrated as having a substantially circular or elliptical shape, those skilled in the art will appreciate that the frame 80 may have any shape that defines an opening capable of capturing animal waste. In one embodiment, the frame 80 is at least partially formed of a strong, lightweight and rust-resistant material such as aluminum or plastic.

The apparatus 800 further comprises at least two flanges 84a and 84b coupled to the outer perimeter 83 and extending outwardly therefrom. The flanges 84a and 84b are positioned substantially directly opposite each other such that the flanges 84a and 84b are adapted to respectively engage the handles of a bag (e.g., a disposable plastic bag such as those used to carry groceries). In one embodiment, the flanges 84a and 84b are substantially L-shaped.

FIG. 9 is a side view of the apparatus 800 of FIG. 8 having a bag 900 deployed thereon for catching animal waste. In one embodiment, the bag 900 is a disposable bag having at least two handles 90a and 90b. In one embodiment of use, the handles 90a and 90b of the bag 900 are looped upward through the inner perimeter 83 of the frame 80 and over the frame 80 to catch the flanges 84a and 84b of the apparatus 800 (e.g., by hanging from the flanges 84a and 84b or by wrapping around the flanges 84a and 84b). Thus, the inner volume 92 of the bag 900 is aligned with the opening 82 of the frame 80. In this manner, the bag 900 may be secured to the frame 80 so that when the apparatus 800 is positioned beneath or behind an animal, waste is captured in the bag 900 for disposal.

Referring back to FIG. 8, in one embodiment, the apparatus 800 further comprises a handle 85 extending outwardly from the outer perimeter 83 of the frame 80. The handle 85 enables a user to manually position the apparatus 800 behind or beneath an animal to catch waste. In the embodiment illustrated, the handle 85 is short and substantially circular in shape; however, the handle 85 may have any shape that enables a user to securely grip the apparatus 800.

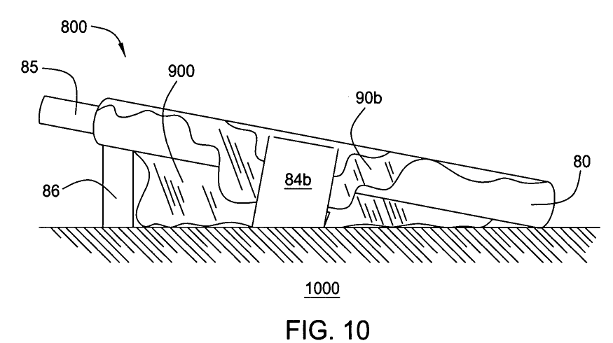

FIG. 10 is a side view of the apparatus 800 being supported upon a support surface 100 (e.g., the ground). As illustrated, in one embodiment, the apparatus 800 further comprises at least one leg 86 coupled to the frame 80 and extending at an angle substantially perpendicular thereto. The leg 86 is adapted to support a portion of the frame 80 in a spaced apart relation relative to the support surface 100, so that a user can position the apparatus 800 behind or beneath an animal without having to hold on to the apparatus 800. In the illustrated embodiment, the leg 86 supports the frame 80 in an angled position relative to the support surface, in conjunction with the flanges 84a and 84b which may double as additional legs for supporting the frame 80.

The apparatus 800 thereby enables easy attachment and removal of the bag 900 from the frame 80 without spilling or subjecting a user to contact with the bag's contents. Moreover, the configuration of the frame 80 and flanges 84a and 84b allows the apparatus 800 to be used with common disposable bags (such as those used to carry groceries) that many users will have readily available (i.e., there is no need to obtain special bags for use with the apparatus 800).

Thus, the present invention represents a significant advancement in the field of animal waste collection and disposal. An apparatus is provided for enabling a pet owner to dispose of animal waste in a simple and sanitary manner. Bags for waste collection are attached to a support frame by two or more flanges that engage handles on the bag, thereby enabling easy attachment and removal of a bag from the frame without spilling or subjecting a user to contact with the contents.

Although various embodiments which incorporate the teachings of the present invention have been shown and described in detail herein, those skilled in the art can readily devise many other varied embodiments that still incorporate these teachings.

What is claimed is:

1. Apparatus for collecting animal waste comprising:
a frame having an inner perimeter defining an opening and an outer perimeter;
at least two flanges coupled to the outer perimeter of the frame for securing a bag to the frame; and
at least one leg coupled to the frame for supporting the frame in a spaced apart relation relative to a support surface.

2. The apparatus of claim 1, wherein the at least two flanges are for engaging handles on the bag.

3. The apparatus of claim 1, wherein the at least two flanges are positioned substantially directly opposite each other.

4. The apparatus of claim 1, further comprising a handle coupled to the outer perimeter of the frame.

5. The apparatus of claim 4, wherein the handle is substantially circular in shape.

6. The apparatus of claim 1, wherein the frame is substantially circular in shape.

7. The apparatus of claim 1, wherein the opening is for aligning with an interior volume of the bag.

8. The apparatus of claim 1, wherein the apparatus is at least partially formed of a strong but lightweight material.

9. The apparatus of claim 8, wherein the apparatus is at least partially formed of aluminum.

10. The apparatus of claim 8, wherein the apparatus is at least partially formed of plastic.

11. The apparatus of claim 1, wherein the at least two flanges are further for supporting the frame in a spaced apart relation relative to a support surface.

12. The apparatus of claim 1, wherein the at least one leg is substantially L-shaped.

13. Apparatus for collecting animal waste comprising:
means for supporting a bag;
means for securing the bag to the support means; and
means for propping said support means in a spaced apart relation relative to a support surface.
